(19) United States
(12) Patent Application Publication
(10) Pub. No.: US 2026/0291972 A1
(43) Pub. Date: Sep. 24, 2026

(54) CYBERSECURITY ASSESSMENT, ATTESTATION, AND IMPLEMENTATION SYSTEM AND METHOD OF USE

(71) Applicant: Edward Bezerra, Mountainside, NJ (US)

(72) Inventor: Edward Bezerra, Mountainside, NJ (US)

(21) Appl. No.: 19/088,534

(22) Filed: Mar. 24, 2025

(51) Int. Cl. H04L 9/40

(52) U.S. Cl. CPC H04L 63/1433

(57) ABSTRACT

A cybersecurity assessment, attestation, and implementation system for safely connecting a first computer network (FCN) to a second computer network (SCN) includes a security server. The security server comprises a memory component, which has computer-executable instructions stored thereon, and one or more processors, which are operatively coupled to the memory component. The processors execute the computer-executable instructions to selectively network the security server with the FCN and the SCN, to execute a cybersecurity assessment of the FCN to detect a vulnerability in the FCN, to generate a recommendation to redress the vulnerability should one be identified, to generate a certificate attesting to the FCN meeting a predetermined standard and being qualified for networking with the SCN, to perform routine monitoring of the FCN, and to selectively implement a networking restriction on the FCN upon detection of the vulnerability.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to cybersecurity systems and more particularly pertains to a new cybersecurity system for safely connecting a first computer network (FCN) to a second computer network (SCN). Prior art cybersecurity systems often address cybersecurity at a technical level without fostering trust between an operator of the FCN and the operator of the SCN. A cybersecurity system that strengthens the cybersecurity posture of the FCN and its operator and provides a verifiable certification that the operator of the SCN can rely upon would create a clear and standardized mechanism to evaluate the FCN's security and thereby reduce the uncertainty and risk associated with third-party relationships. Additionally, routine monitoring of the FCN with selective implementation of a networking restriction on the FCN, upon detection of a vulnerability or noncompliance with a predetermined standard, would foster trust in networking the SCN to the FCN.

### (2) Description of Related Art Including Information Disclosed Under 37 CFR 1.97 and 1.98

The prior art relates to cybersecurity systems but which do not include generation of a certificate verifying that an FCN can be safely networked with an SCN and which do not include routine monitoring of the FCN with selective implementation of a networking restriction. The present invention provides an avenue for small and medium-sized businesses that operate FCNs to bridge the trust gap between themselves and large enterprises which is not cost-prohibitive or overly complex, but rather a tailored, user-friendly invention that empowers these for small and medium-sized businesses to achieve and demonstrate a high level of cybersecurity compliance.

### (h) BRIEF SUMMARY OF THE INVENTION

An embodiment of the disclosure meets the needs presented above by generally comprising a security server. The security server comprises a memory component, which has computer-executable instructions stored thereon, and one or more processors, which are operatively coupled to the memory component. The one or more processors are configured to execute the computer-executable instructions to:
i. selectively network the security server with a first computer network (FCN) and a second computer network (SCN),
ii. execute a cybersecurity assessment of the FCN to detect a vulnerability in the FCN relative to a predetermined standard,
iii. generate a recommendation to redress the vulnerability should one be identified during the cybersecurity assessment,
iv. generate a certificate attesting to the FCN meeting the predetermined standard and being qualified to network with the SCN,
v. perform routine monitoring of the FCN, and
vi. selectively implement a networking restriction on the FCN upon detection of the vulnerability.

Another embodiment of the disclosure includes a method for a cybersecurity assessment, attestation, and implementation system for reducing cybersecurity risks when networking an FCN to a SCN. The method comprises the following steps:
i. selectively networking, by the one or more processors, of the security server with an FCN and a second computer network,
ii. executing, by the one or more processors, of a cybersecurity assessment of the FCN to detect a vulnerability in the FCN relative to a predetermined standard,
iii. generating, by the one or more processors, of a recommendation for redressing the vulnerability should one be identified during the cybersecurity assessment,
iv. generating, by the one or more processors, of a certificate attesting to the FCN meeting the predetermined standard and is qualified for networking with the second computer network,
v. performing, by the one or more processors, of routine monitoring of the FCN, and
vi. selectively implementing, by the one or more processors, of a networking restriction upon detection of the vulnerability. The networking restriction is predeterminable by the operator of the SCN.

Yet another embodiment of the disclosure includes a non-transitory computer-readable storage medium that has computer-executable instructions stored thereon, which, when executed by one or more processors, cause the one or more processors to perform operations comprising:
i. selectively networking a security server comprising the one or more processors with an FCN and an SCN,
ii. executing a cybersecurity assessment of the FCN to detect a vulnerability in the FCN relative to a predetermined standard,
iii. generating a recommendation for redressing the vulnerability should one be identified during the cybersecurity assessment,
iv. generating a certificate attesting to the FCN meeting the predetermined standard and is qualified for networking with the SCN,
v. performing routine monitoring of the FCN, and
vi. selectively implementing of a networking restriction upon detection of the vulnerability.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a block diagram of a cybersecurity assessment, attestation, and implementation system according to an embodiment of the disclosure.

FIG. 2 is an overview flowchart of an embodiment of the disclosure.

FIG. 3 is a detailed flowchart of an embodiment of the disclosure.

FIG. 4 is a detailed flowchart view of an embodiment of the disclosure.

FIG. 5 is a detailed flowchart view of an embodiment of the disclosure.

FIG. 6 is a flowchart for a method utilizing an embodiment of the disclosure.

### (j) DETAILED DESCRIPTION OF THE INVENTION

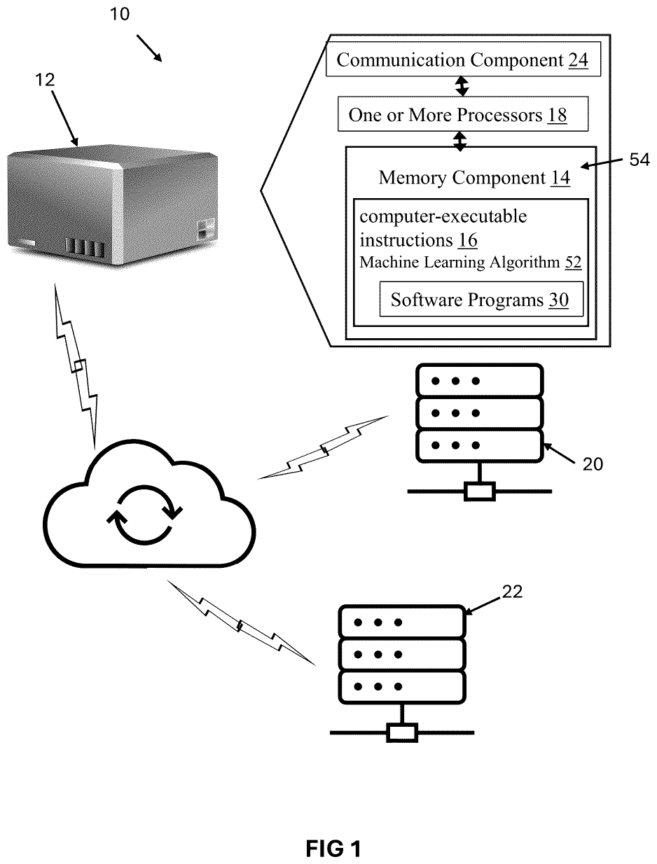

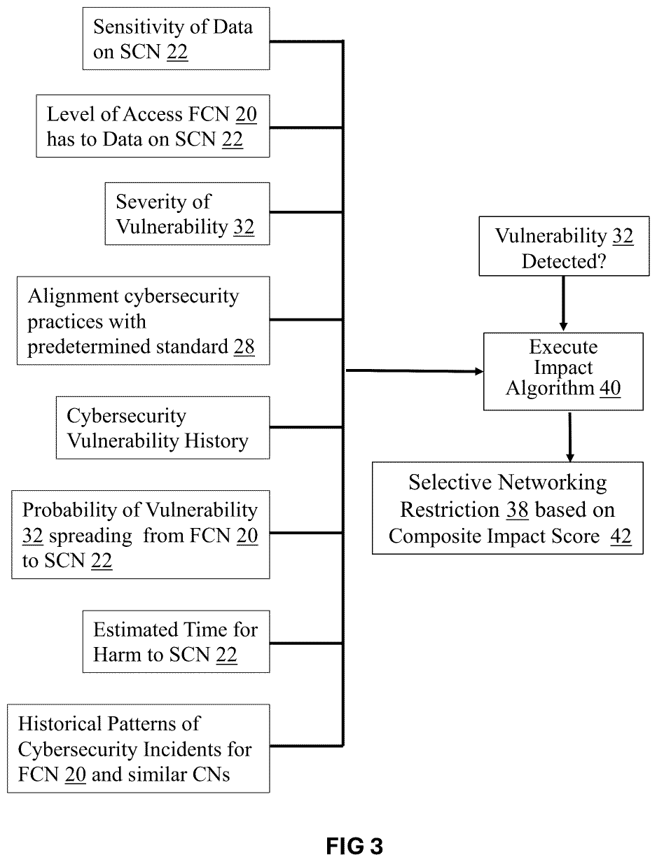

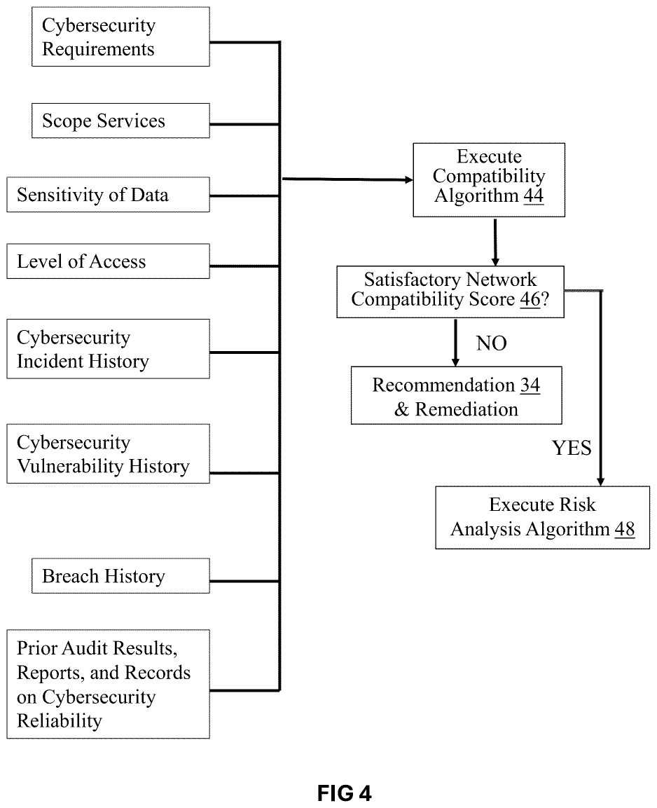

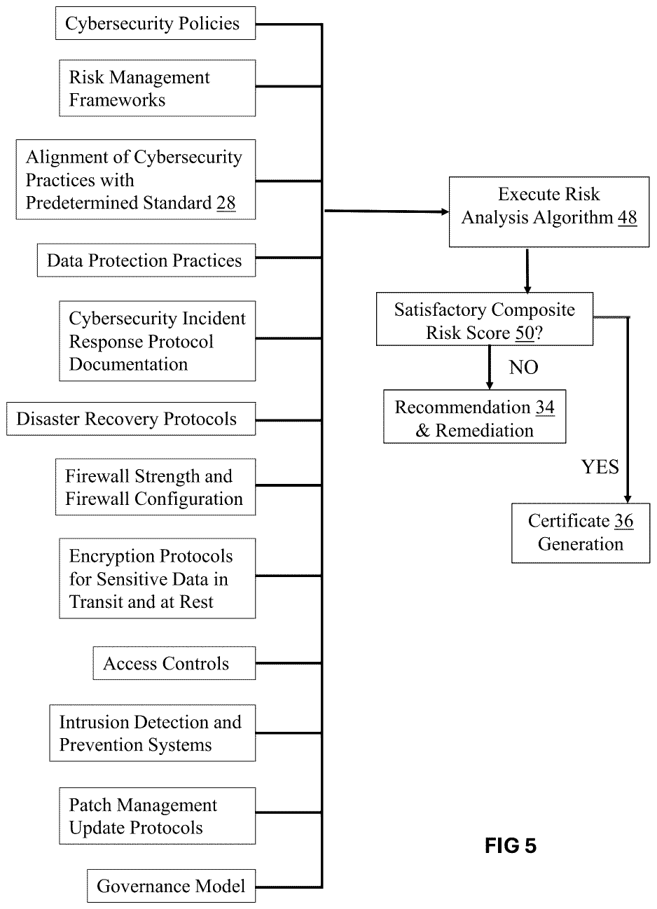

With reference now to the drawings, and in particular to FIGS. 1 through 6 thereof, a new cybersecurity system embodying the principles and concepts of an embodiment of the disclosure and generally designated by the reference numeral 10 will be described.

As best illustrated in FIGS. 1 through 6, the cybersecurity assessment, attestation, and implementation system 10 generally comprises a security server 12. The security server 12 comprises a memory component 14, which has computer-executable instructions 16 stored thereon, and one or more processors 18, which are operatively coupled to the memory component 14. The one or more processors 18 are well known to those skilled in the art of server and computer hardware and may comprise a variety of types of components, such as, but not limited to, digital signal processor components, microprocessors, digital-to-analog converters, analog-to-digital converters, and various support circuits. The one or more processors 18 are configured to execute the computer-executable instructions 16 to:
i. selectively network the security server 12 with a first computer network 20 (FCN) and a second computer network 22 (SCN) using a communication component(s) 24 well known to those skilled in the art of networking. While the security server 12 need not necessarily be networked with the SCN 22 for the invention to operate, it is anticipated that in some circumstances such networking will improve performance, such as when assessing compatibility of the FCN 20 with the SCN 22. Such networking can be achieved using components and methods well known to those skilled in the art of networking,
ii. execute a cybersecurity assessment 26 of the FCN 20 to detect a vulnerability 32 in the FCN 20 relative to a predetermined standard 28, such as, but not limited to, an industry standard, a regulatory standard, or the like. “Vulnerability” in the context of this disclosure should be interpreted to mean noncompliance with the predetermined standard 28, a data breach of the FCN 20, detection of malicious software (viruses, malware, spyware, ransomware, or the like) on the FCN 20, or the like. The one or more processors 18 typically will operate one or more software programs 30 stored in the memory component 14 to effect the cybersecurity assessment 26, The cybersecurity assessment 26 typically will include one or more of penetration testing, scanning for known vulnerabilities, assessing cybersecurity configuration, assessing endpoint protection, assessing data security, or the like,
iii. generate a recommendation 34 to redress the vulnerability 32 should one be identified during the cybersecurity assessment 26. Remediation of the vulnerability 32 might entail, for example, implementing stronger encryption protocols, patching software vulnerabilities, improving employee security training, or the like,
iv. generate a certificate 36 attesting to the FCN 20 meeting the predetermined standard 28 and being qualified to network with the SCN 22. The cybersecurity assessment, attestation, and implementation system 10 may automatically alert the operator of the FCN 20 and/or the operator of the SCN 22 when remediation and certification are completed and also may issue a formal certificate 36 attesting that the FCN 20 is secure and compliant and/or a Seal of Approval for use in FCN 20 marketing materials and client communications,
v. perform routine monitoring of the FCN 20, which may be performed automatically and continuously in real-time or automatically at prescribed intervals, such as, but not limited to, hourly, daily, weekly, or the like, to identify the vulnerability 32. Routine monitoring may comprise one or more of verification of regular security audits, penetration testing, and verification of tracking of and adaption to industry security trends, or the like. Detection of a vulnerability 32 may trigger an alert to the operator of the FCN 20, who then may work to redress the vulnerability 32, as well as an alert to the operator of the security server 12, and
vi. selectively implement a networking restriction 38 on the FCN 20 upon detection of the vulnerability 32. The networking restriction 38 is predeterminable by the operator of the SCN 22. The networking restriction 38 is implemented either manually by the operator of the SCN 22, manually by an operator of the security server 12, or automatically by the security server 12. Most typically, the networking restriction 38 would be automatically applied when the vulnerability 32 is detected and would be triggered based on predefined criteria set by the operator of the SCN 22, with the severity of the vulnerability 32, as quantified in the composite impact score 42, determining both the nature (e.g. limiting or terminating access of the FCN 20 to the SCN 22) of the networking restriction 38 and when the networking restriction 38 is enacted. The automatic application of the networking restriction 38 ensures that the vulnerability 32 is promptly addressed, maintaining continuous protection, and reducing the likelihood of an escalating security incident. A proactive and real-time response would help businesses safeguard their interests, such as supply chains, internal and customer data, trade secrets, and the like, by ensuring compliance and minimizing exposure to cyber threats.

The computer-executable instructions 16 includes an impact algorithm 40. The one or more processors 18 are configured to execute the computer-executable instructions to generate a composite impact score 42 for a potential adverse impact of the vulnerability 32 in the FCN 20 on the SCN 22 based upon two or more of:
i. a sensitivity of the data on the SCN 22 to which the FCN 20 has access,
ii. a level of the access the FCN 20 has to the data on the SCN 22. The impact algorithm 40 examines how much access the FCN 20 has to the SCN 22, especially sensitive data and critical systems of the SCN 22. Broader access to the sensitive data and the critical systems pose a higher risk to the operator of the SCN 22 if compromised.
iii. a severity for the vulnerability 32 based on a predefined scoring model, such as the Common Vulnerability Scoring System (CVSS), which provides a numerical value to measure the impact of the vulnerability 32,
iv. a degree of alignment of the cybersecurity practices of the operator of the FCN 20 with the predetermined standard 28. The impact algorithm 40 assess the degree of alignment of the FCN 20's cybersecurity practices with the predetermined standard 28, which may include industry standards, regulatory requirements, or the like. For example, the predetermined standard 28 may comprise one or more of System and Organization Controls 2 (SOC2), General Data Protection Regulation (GDPR), Health Insurance Portability and Accountability Act (HIPAA), or the like. Noncompliance with the predetermined standard 28 increases the risk of legal and financial repercussions for the operator of the SCN 22,
v. a probability that the vulnerability 32 could spread from the FCN 20 to the SCN 22 or beyond to other networks operated by the operator or the SCN 22 or connected to the SCN 22. If the vulnerability 32 has the potential to escalate into a wider breach, the impact could be far-reaching,
vi. an estimated time between detecting the vulnerability 32 and when the vulnerability 32 could cause harm to the SCN 22. This estimated time helps prioritize the application of a networking restriction 38 based on the urgency of the cybersecurity incident, and
vii. historical patterns of cybersecurity incidents inclusive of past cybersecurity incidents involving the FCN 20 and similar computer networks to estimate the likelihood of future cybersecurity incidents and their potential impact.

The impact algorithm 40 is a critical component of the cybersecurity assessment, attestation, and implementation system 10 and is designed to generate the composite impact score 42 for the potential adverse impact of the vulnerability 32 in the FCN 20 on the SCN 22. The impact algorithm 40 operates by analyzing multiple factors to determine the severity of the vulnerability 32, which then informs the appropriate preventive actions. A networking restriction 38 is selectable by the operator of the SCN 22 for selective implementation should the composite impact score 42 for the potential adverse impact exceed a value set by the operator of the SCN 22.

The computer-executable instructions 16 also includes a compatibility algorithm 44. The one or more processors 18 are configured to execute the computer-executable instructions 16 to generate a network compatibility score 46 based upon two or more of:
i. cybersecurity requirements necessary for types of services that the operator of the FCN 20 will provide to the operator of the SCN 22,
ii. a scope of the of services to be provided by the operator of the FCN 20 to the operator of the SCN 22 to assess whether the scope of the of services increase exposure to cyber threats. Items i. and ii. assess the security measures required for these the type and scope of the services to ensuring that the FCN 20 can safely interface with the SCN 22,
iii. a sensitivity of the data on the SCN 22 to which the FCN 20 has access,
iv. a level of the access the FCN 20 has to the data on the SCN 22 to assess the criticality of the data or systems being accessed and identifying any potential weaknesses due to elevated access rights,
v. a history of previous cybersecurity incidents involving the FCN 20,
vi. a history of previous cybersecurity vulnerabilities in the FCN 20,
vii. a history of previous breaches of the FCN 20, and
viii. previous audit results, reports, and records to assess cybersecurity reliability of the FCN 20 over time.

The one or more processors 18 also are configured to execute the computer-executable instructions 16 to generate a recommendation 34 to redress an unsatisfactory network compatibility score 46 should one be obtained.

The computer-executable instructions 16 also includes a risk analysis algorithm 48. The one or more processors 18 are configured to execute the computer-executable instructions 16 to generate a composite risk score 50 based upon two or more of the following attributes of either the FCN 20 or the operator thereof:
i. cybersecurity policies,
ii. risk management frameworks,
iii. a degree of alignment of the cybersecurity practices with the predetermined standard 28;
iv. data protection practices,
v. cybersecurity incident response protocol documentation,
vi. disaster recovery protocols,
vii. firewall strength and firewall configuration,
viii. encryption protocols for sensitive data in transit and at rest,
ix. access controls, including one or more of authentication mechanisms, access restrictions, and multi-factor authentication practices,
x. intrusion detection and prevention systems,
xi. patch management update protocols, and
xii. governance model ensuring appropriate oversight of cybersecurity practices including one or more of employee training protocols, testing of cybersecurity incident response protocols, adherence to industry-specific compliance standards, such as, but not limited to, GDPR, HIPAA, Payment Card Industry Data Security Standard, or the like, and auditing for adherence to cybersecurity protocols.

The one or more processors 18 also are configured to execute the computer-executable instructions 16 to generate a recommendation 34 to redress an unsatisfactory composite risk score 50 should one be obtained. The composite risk score 50 may be based on a predefined scoring model, such as, but not limited to, Common Vulnerability Scoring System, Exploit Prediction Scoring System, Open Web Application Security Project Risk Rating Methodology, or the like, which prioritize risks based on severity. As will be apparent to those skilled in the art of cybersecurity assessments, the compatibility algorithm 44 and the risk analysis algorithm 48 could comprise a single algorithm generating a singular score combining compatibility and risk along with one or more recommendations 34 to redress an unsatisfactory singular score.

The computer-executable instructions 16 also includes a machine learning algorithm 52. The one or more processors 18 are configured to execute the computer-executable instructions 16 to anticipate risk based on operational patterns of the FCN 20 and external threat intelligence and to selectively implement a networking restriction 38 prior to full manifestation of the vulnerability 32. The machine learning algorithm 52 of the cybersecurity assessment, attestation, and implementation system 10 enables predictive blocking by analyzing operational patterns of the FCN 20 and integrating external threat intelligence. By leveraging historical data, network behavior analysis, and real-time threat feeds, the machine learning algorithm 52 can detect early indicators of vulnerabilities or noncompliance before they fully manifest. This predictive capability allows the cybersecurity assessment, attestation, and implementation system 10 to proactively apply networking restrictions 38 to the FCN 20's access to the SCN 22 based on anticipated risks, significantly reducing the chances of a breach or compromise. The machine learning algorithm 52 continuously improves its accuracy by learning from new data and adjusting predictions based on emerging threats, ensuring an evolving and adaptive risk management process.

Another embodiment of the invention includes a non-transitory computer-readable storage medium 54, which has computer-executable instructions 16 stored thereon. The computer-executable instructions 16, when executed by one or more processors 18, cause the one or more processors 18 to perform operations comprising:
i. selectively networking a security server 12 comprising the one or more processors 18 with an FCN 20 and an SCN 22,
ii. executing a cybersecurity assessment 26 of the FCN 20 to detect a vulnerability 32 in the FCN 20 relative to a predetermined standard 28,
iii. generating a recommendation 34 for redressing the vulnerability 32 should one be identified during the cybersecurity assessment 26,
iv. generating a certificate 36 attesting to the FCN 20 meeting the predetermined standard 28 and being qualified for networking with the SCN 22,
v. performing routine monitoring of the FCN 20, and
vi. selectively implementing of a networking restriction 38 upon detection of the vulnerability 32.

The computer-executable instructions 16 also may include an impact algorithm 40, which when executed by the one or more processors 18, cause the one or more processors 18 to perform operations comprising:
i. generating a composite impact score 42 for the vulnerability 32 in the FCN 20 on the SCN 22 based upon two or more of the parameters discussed above for the cybersecurity assessment, attestation, and implementation system 10, and
ii. and implementing a networking restriction 38, predeterminable by the operator of the SCN 22, should the composite score for the potential adverse impact fail exceed a value set by the operator of the SCN 22.

The computer-executable instructions 16 also may include a compatibility algorithm 44, which when executed by the one or more processors 18, cause the one or more processors 18 to perform operations comprising:
i. generating a network compatibility score 46 based upon two or more of the parameters discussed above for the cybersecurity assessment, attestation, and implementation system 10, and
ii. generating a recommendation 34 for redressing an unsatisfactory network compatibility score 46 should one be obtained.

The computer-executable instructions 16 also may include a risk analysis algorithm 48, which when executed by the one or more processors 18, cause the one or more processors 18 to perform operations comprising:
i. generating a composite risk score 50 based upon two or more of the attributes of either the FCN 20 or the operator thereof, as discussed above for the cybersecurity assessment, attestation, and implementation system 10, and
ii. generating a recommendation 34 to redress an unsatisfactory composite risk score 50 should one be obtained.

The computer-executable instructions 16 also may include a machine learning algorithm 52, which when executed by the one or more processors 18, cause the one or more processors 18 to perform operations comprising:
i. anticipating risk to the SCN 22, based on operational patterns of the FCN 20 and external threat intelligence, and
ii. selectively implementing a networking restriction 38 prior to full manifestation of the vulnerability 32.

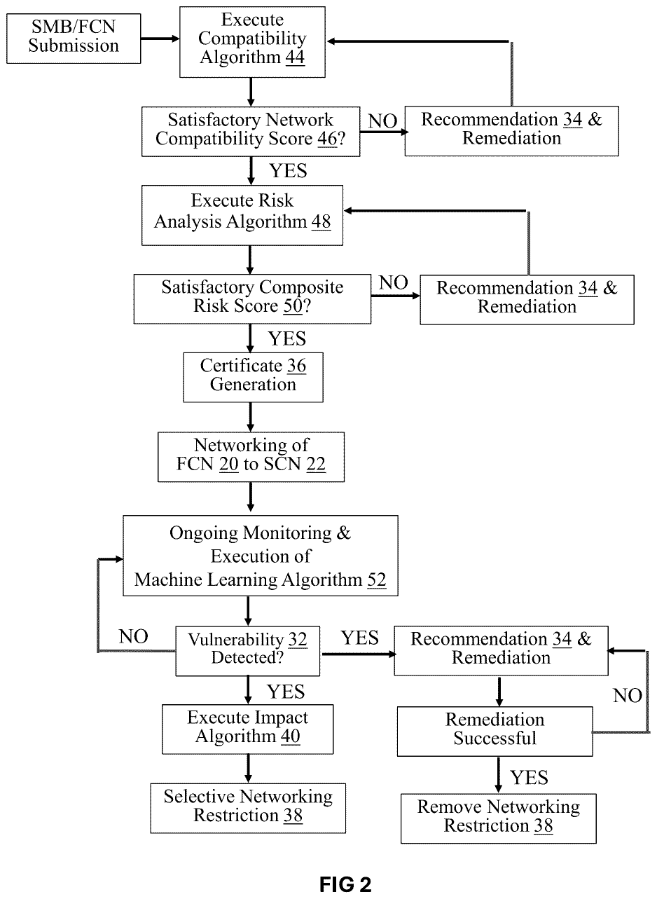

By way of a particular, non-limiting example of implementation of the cybersecurity assessment, attestation, and implementation system 10, and as exemplified in the flowchart of FIG. 2, a small business owner operating an FCN 20 applies to the operator of the security server 12 for certification to connect to an SCN 22 being operated by another business.

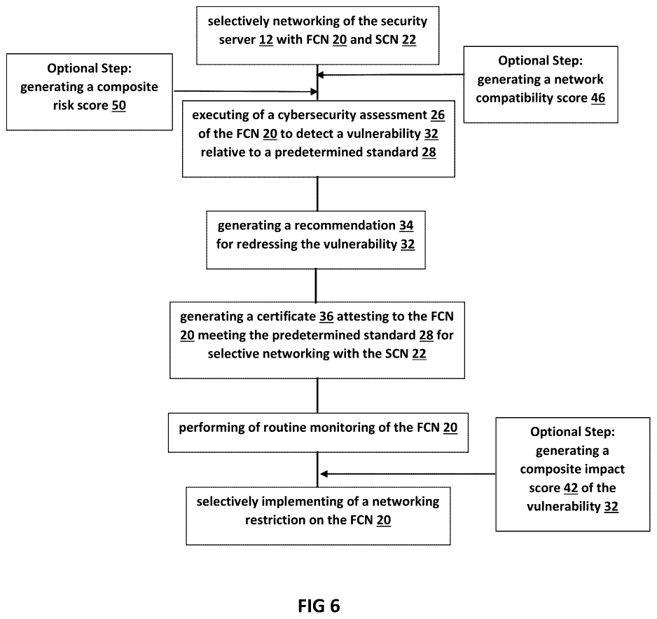

In use, a computer implemented method 56, as is shown in FIG. 6, is enabled by the cybersecurity assessment, attestation, and implementation system 10. The computer implemented method 56 reduces cybersecurity risks when networking an FCN 20 to an SCN 22. The method comprises the following steps:
i. selectively networking, by one or more processors 18, of the security server 12 with the FCN 20 and the SCN 22,
ii. executing, by the one or more processors 18, of a cybersecurity assessment 26 of the FCN 20 to detect a vulnerability 32 in the FCN 20 relative to a predetermined standard 28,
iii. generating, by the one or more processors 18, of a recommendation 34 for redressing the vulnerability 32 should one be identified during the cybersecurity assessment 26,
iv. generating, by the one or more processors 18, of a certificate 36 attesting to the FCN 20 meeting the predetermined standard 28 and is qualified for networking with the SCN 22,
v. performing, by the one or more processors 18, of routine monitoring of the FCN 20, and
vi. selectively implementing, by the one or more processors 18, of a networking restriction 38 upon detection of a vulnerability 32. The networking restriction 38 is predeterminable by the operator of the SCN 22.

The computer implemented method 56 may comprise an additional step of the one or more processors 18 generating a composite impact score 42 of the vulnerability 32 in the FCN 20 upon the SCN 22 based upon two or more of the parameters discussed above for the cybersecurity assessment, attestation, and implementation system 10. The networking restriction 38 then is selectable by the operator of the SCN 22 for selective implementation should the composite impact score 42 for the potential adverse impact fail exceed a value set by the operator of the SCN 22.

The computer implemented method 56 may comprise an additional step of generating, by the one or more processors 18, of a network compatibility score 46, based upon two or more of the parameters discussed above for the cybersecurity assessment, attestation, and implementation system 10, and a recommendation 34 for redressing an unsatisfactory network compatibility score 46 should one be obtained. Typically, the network compatibility score 46 would be generated as an initial screen to assess whether or not the FCN 20 is compatible with an SCN 22. An iterative process may be employed until the FCN 20 achieve an acceptable network compatibility score 46.

The computer implemented method 56 may comprise an additional step generating, by the one or more processors 18, of a composite risk score 50 based upon two or more of the attributes of either the FCN 20 or the operator thereof, as was discussed above for the cybersecurity assessment, attestation, and implementation system 10. The method also includes an additional step of generating, by the one or more processors 18, of a recommendation 34 to redress an unsatisfactory composite risk score 50 should one be obtained. Typically, the composite risk score 50 would be generated after the FCN 20 achieves an acceptable network compatibility score 46. Again, an iterative process may be employed until the FCN 20 achieve an acceptable composite risk score 50.

The computer implemented method 56 may comprise an additional step of anticipating, by the one or more processors 18, risk and selectively implementing a networking restriction 38 prior to full manifestation of a vulnerability 32, as is described in detail above for the cybersecurity assessment, attestation, and implementation system 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cybersecurity assessment, attestation, and implementation system comprising:
a security server comprising:
a memory component having computer-executable instructions stored thereon; and
one or more processors operatively coupled to the memory component, wherein the one or more processors are configured to execute the computer-executable instructions for:
selectively networking the security server with a first computer network and a second computer network;
executing a cybersecurity assessment of the first computer network to detect a vulnerability in the first computer network relative to a predetermined standard;
generating a recommendation for redressing the vulnerability in the first computer network after the vulnerability in the first computer network is identified during the cybersecurity assessment;
generating a certificate attesting to the first computer network meeting the predetermined standard and being qualified for networking with the second computer network;
performing routine monitoring of the first computer network; and
selectively implementing a networking restriction on the first computer network upon detection of the vulnerability.

2. The cybersecurity assessment, attestation, and implementation system of claim 1, wherein the cybersecurity assessment includes one or more of penetration testing, scanning for known vulnerabilities, assessing cybersecurity configuration, assessing endpoint protection, and assessing data security.

3. The cybersecurity assessment, attestation, and implementation system of claim 1, further including:
the computer-executable instructions including an impact algorithm, wherein the one or more processors are configured to execute the computer-executable instructions for:
generating a composite impact score for a potential adverse impact of the vulnerability in the first computer network on the second computer network based upon two or more of:
a sensitivity of the data on the second computer network to which the first computer network has access;
a level of the access the first computer network has to the data on the second computer network;
a severity for the vulnerability based on a predefined scoring model;
a degree of alignment of the cybersecurity practices of the operator of the first computer network with the predetermined standard;
a probability that the vulnerability could spread from the first computer network to the second computer network;
an estimated time before harm is inflicted upon the second computer network; and
historical patterns of cybersecurity incidents inclusive of past cybersecurity incidents involving the first computer network and similar computer networks; and
a networking restriction being selectable by the operator of the second computer network for selective implementation should the composite impact score for the potential adverse impact fail exceed a value set by the operator of the second computer network, the networking restriction being predeterminable by the operator of the second computer network, the networking restriction being implemented either manually by the operator of the second computer network, manually by an operator of the security server, or automatically by the security server.

4. The cybersecurity assessment, attestation, and implementation system of claim 1, further including the computer-executable instructions including a compatibility algorithm, wherein the one or more processors are configured to execute the computer-executable instructions for:
generating a network compatibility score based upon two or more of:
cybersecurity requirements necessary for types of services that the operator of the first computer network will provide to the operator of the second computer network;
a scope of the of services to be provided by the operator of the first computer network to the operator of the second computer network to assess whether the scope of the of services increase exposure to cyber threats;
a sensitivity of the data on the second computer network to which the first computer network has access;
a level of the access the first computer network has to the data on the second computer network;
a history of previous cybersecurity incidents involving the first computer network;
a history of previous cybersecurity vulnerabilities in the first computer network;
a history of previous breaches of the first computer network; and
previous audit results, reports, and records to assess cybersecurity reliability of the first computer network over time; and
generating a recommendation for improving the network compatibility score should improvement be required.

5. The cybersecurity assessment, attestation, and implementation system of claim 4, further including the computer-executable instructions including a risk analysis algorithm, wherein the one or more processors are configured to execute the computer-executable instructions for:
generating a composite risk score based upon two or more of the following attributes of either the first computer network or the operator thereof:
cybersecurity policies;
risk management frameworks;
a degree of alignment of the cybersecurity practices with the predetermined standard;
data protection practices;
cybersecurity incident response protocol documentation;
disaster recovery protocols;
firewall strength and firewall configuration;
encryption protocols for sensitive data in transit and at rest;
access controls, including one or more of authentication mechanisms, access restrictions, and multi-factor authentication practices;
intrusion detection and prevention systems;
patch management update protocols; and
governance model ensuring appropriate oversight of cybersecurity practices including one or more of employee training protocols, testing of cybersecurity incident response protocols, adherence to industry-specific compliance standards, and auditing for adherence to cybersecurity protocols; and
generating a recommendation for improving the composite risk score should improvement be required.

6. The cybersecurity assessment, attestation, and implementation system of claim 1, further including the computer-executable instructions including a machine learning algorithm, wherein the one or more processors are configured to execute the computer-executable instructions for:
anticipating risk based on operational patterns of the first computer network and external threat intelligence; and
selectively implementing the networking restriction prior to full manifestation of the vulnerability.

7. A computer implemented method for a cybersecurity assessment, attestation, and implementation system for reducing cybersecurity risks when networking a first computer network to a second computer network, the method comprising the steps of:
selectively networking, by one or more processors, of a security server with a first computer network and a second computer network;
executing, by the one or more processors, of a cybersecurity assessment of the first computer network to detect a vulnerability in the first computer network relative to a predetermined standard;
generating, by the one or more processors, a recommendation for redressing the vulnerability in the first computer network after the vulnerability in the first computer network is identified during the cybersecurity assessment;
generating, by the one or more processors, of a certificate attesting to the first computer network meeting the predetermined standard and being qualified for networking with the second computer network;
performing, by the one or more processors, of routine monitoring of the first computer network; and
selectively implementing, by the one or more processors, of a networking restriction on the first computer network upon detection of the vulnerability, the networking restriction being predeterminable by the operator of the second computer network.

8. The computer implemented method of claim 7, wherein the cybersecurity assessment includes one or more of penetration testing, scanning for known vulnerabilities, assessing cybersecurity configuration, assessing endpoint protection, and assessing data security.

9. The computer implemented method of claim 7, further including:
the method including an additional step of generating, by the one or more processors, a composite impact score of the vulnerability in the first computer network on the second computer network based upon two or more of:
a sensitivity of the data on the second computer network to which the first computer network has access;
a level of the access the first computer network has to the data on the second computer network;
a severity for the vulnerability based on a predefined scoring model;
a degree of alignment of the cybersecurity practices of the operator of the first computer network with the predetermined standard;
a probability that the vulnerability could spread from the first computer network to the second computer network;
an estimated time before harm is inflicted upon the second computer network; and
historical patterns of cybersecurity incidents inclusive of past cybersecurity incidents involving the first computer network and similar computer networks; and
the networking restriction being selectable by the operator of the second computer network for selective implementation should the composite impact score for the potential adverse impact fail exceed a value set by the operator of the second computer network.

10. The computer implemented method of claim 7, further including:
the method including an additional step of generating, by the one or more processors, of a network compatibility score for the first computer network with the second computer network based upon two or more of:
cybersecurity requirements necessary for types of services that the operator of the first computer network will provide to the operator of the second computer network;
a scope of the of services to be provided by the operator of the first computer network to the operator of the second computer network to assess whether the scope of the of services increase exposure to cyber threats;
a sensitivity of the data on the second computer network to which the first computer network has access;
a level of the access the first computer network has to the data on the second computer network;
a history of previous cybersecurity incidents involving the first computer network;
a history of previous cybersecurity vulnerabilities in the first computer network;
a history of previous breaches of the first computer network; and
previous audit results, reports, and records to assess cybersecurity reliability of the first computer network over time; and
the method including an additional step of generating, by the one or more processors, a recommendation for improving the network compatibility score should improvement be required.

11. The computer implemented method of claim 10, further including:
the method including an additional step of generating, by the one or more processors, of a composite risk score based upon two or more of the following attributes of either the first computer network or the operator thereof:
cybersecurity policies;
risk management frameworks;
a degree of alignment of the cybersecurity practices with the predetermined standard;
data protection practices;
cybersecurity incident response protocol documentation;
disaster recovery protocols;
firewall strength and firewall configuration;
encryption protocols for sensitive data in transit and at rest;
access controls, including one or more of authentication mechanisms, access restrictions, and multi-factor authentication practices;
intrusion detection and prevention systems;
patch management update protocols; and
governance model ensuring appropriate oversight of cybersecurity practices including one or more of employee training protocols, testing of cybersecurity incident response protocols, adherence to industry-specific compliance standards, and auditing for adherence to cybersecurity protocols; and
the method including an additional step of generating, by the one or more processors, a recommendation for improving the composite risk score should improvement be required.

12. The computer implemented method of claim 7, further including:
the method including an additional step of anticipating risk, by the one or more processors, based on operational patterns of the first computer network and external threat intelligence;
the method including an additional step selectively implementing, by the one or more processors, of the networking restriction prior to full manifestation of the vulnerability.

13. A non-transitory computer-readable storage medium having computer-executable instructions stored thereon, which when executed by one or more processors, cause the one or more processors to perform operations comprising:
selectively networking a security server comprising the one or more processors with a first computer network and a second computer network;
executing a cybersecurity assessment of the first computer network to detect a vulnerability in the first computer network relative to a predetermined standard;
generating a recommendation for redressing the vulnerability in the first computer network after the vulnerability in the first computer network is identified during the cybersecurity assessment;
generating a certificate attesting to the first computer network meeting the predetermined standard and being qualified for networking with the second computer network;
performing routine monitoring of the first computer network; and
selectively implementing of a networking restriction on the first computer network upon detection of the vulnerability.

14. The non-transitory computer-readable storage medium of claim 13, wherein the cybersecurity assessment includes one or more of penetration testing, scanning for known vulnerabilities, assessing cybersecurity configuration, assessing endpoint protection, and assessing data security.

15. The non-transitory computer-readable storage medium of claim 13, further including the computer-executable instructions including an impact algorithm, which when executed by the one or more processors, cause the one or more processors to perform operations comprising:
generating a composite impact score for the vulnerability in the first computer network on the second computer network based upon two or more of:
a sensitivity of the data on the second computer network to which the first computer network has access;
a level of the access the first computer network has to the data on the second computer network;
a severity for the vulnerability based on a predefined scoring model;
a degree of alignment of the cybersecurity practices of the operator of the first computer network with the predetermined standard;
a probability that the vulnerability could spread from the first computer network to the second computer network;
an estimated time before harm is inflicted upon the second computer network; and
historical patterns of cybersecurity incidents inclusive of past cybersecurity incidents involving the first computer network and similar computer networks; and
implementing a networking restriction, predeterminable by the operator of the second computer network, should the composite score for the potential adverse impact fail exceed a value set by the operator of the second computer network.

16. The non-transitory computer-readable storage medium of claim 13, further including the computer-executable instructions including a compatibility algorithm, which when executed by the one or more processors, cause the one or more processors to perform operations comprising:
generating a network compatibility score based upon two or more of:
cybersecurity requirements necessary for types of services that the operator of the first computer network will provide to the operator of the second computer network;
a scope of the of services to be provided by the operator of the first computer network to the operator of the second computer network to assess whether the scope of the of services increase exposure to cyber threats;
a sensitivity of the data on the second computer network to which the first computer network has access;
a level of the access the first computer network has to the data on the second computer network;
a history of previous cybersecurity incidents involving the first computer network;
a history of previous cybersecurity vulnerabilities in the first computer network;
a history of previous breaches of the first computer network; and
previous audit results, reports, and records to assess cybersecurity reliability of the first computer network over time; and
generating a recommendation for improving the network compatibility score should improvement be required.

17. The non-transitory computer-readable storage medium of claim 16, further including the computer-executable instructions including a risk analysis algorithm, which when executed by the one or more processors, cause the one or more processors to perform operations comprising:
generating a composite risk score based upon two or more of the following attributes of either the first computer network or the operator thereof:
cybersecurity policies;
risk management frameworks;
a degree of alignment of the cybersecurity practices the predetermined standard;
data protection practices;
cybersecurity incident response protocol documentation;
disaster recovery protocols;
firewall strength and firewall configuration;
encryption protocols for sensitive data in transit and at rest;
access controls, including one or more of authentication mechanisms, access restrictions, and multi-factor authentication practices;
intrusion detection and prevention systems;
patch management update protocols; and
governance model ensuring appropriate oversight of cybersecurity practices including one or more of employee training protocols, testing of cybersecurity incident response protocols, adherence to industry-specific compliance standards, and auditing for adherence to cybersecurity protocols; and
generating a recommendation for improving the composite risk score should improvement be required.

18. The non-transitory computer-readable storage medium of claim 15, further including the computer-executable instructions including a machine learning algorithm, which when executed by the one or more processors, cause the one or more processors to perform operations comprising:
anticipating risk to the second computer network based on operational patterns of the first computer network and external threat intelligence; and
selectively implementing the networking restriction prior to full manifestation of the vulnerability.
